(19) United States
(12) Patent Application Publication
(10) Pub. No.: US 2008/0059266 A1
(43) Pub. Date: Mar. 6, 2008

(54) RESOURCE MANAGING METHOD AND DEVICE FOR MANAGING DRIVERS

(76) Inventor: Felix Freimann, Sunnyvale, CA (US)

Correspondence Address: NORTH AMERICA INTELLECTUAL PROPERTY CORPORATION, P.O. BOX 506, MERRIFIELD, VA, 22116, US

(21) Appl. No.: 11/468,760

(22) Filed: Aug. 30, 2006

(51) Int. Cl. G06F 9/46

(52) U.S. Cl. 705/8

(57) ABSTRACT

A method for managing drivers includes receiving registration information of a plurality of drivers and storing the registration information of the drivers; receiving interconnection information of the drivers and storing the interconnection information of the drivers; receiving at least a request to activate a specific driver of the drivers; searching the registration information for the specific driver; and referencing the interconnection information to determine whether the specific driver can be activated in response to the request.

### BACKGROUND

The present invention relates generally to a resource managing device in a computing system and related method, and more specifically, to a resource managing device in a computing system for driver registration and the related method.

As is well known by those of average skill in the art, when a handler of a computing system requires a specific driver component, for example, a video decoder driver component, a tuner driver component, or some other driver component, the handler does not have a logical view of the driver components that are available in the computing system. The component can be, for example, said video decoder, tuner, or any other number of driver components. The handler can be, for example, an application of the computing system that requests to use any one or more of the available driver components.

The software, i.e., said application, must have specific knowledge of the underlying hardware of the computing system because, as mentioned earlier, an overall logical view of driver components is not available to the application. It is inefficient for specifications of the computing system hardware to reside in said hardware. When this is the case, the software application handlers must guess using trial and error which driver to utilize. The operation of driver components and handlers is well known to a person of average skill in the pertinent art; therefore, additional details are omitted for the sake of brevity.

Therefore, it is apparent that new and improved methods and devices are needed to solve the above-mentioned problems.

### SUMMARY

It is therefore one of the objectives of the claimed invention to provide a method and device for offering a hardware abstraction view of a computing system for drivers of the computing system. Knowledge of drivers and the valid interactions between the drivers is relocated from the computing system hardware to a software resource manager.

According to an embodiment of the claimed invention, a resource managing method for drivers in a computing system is disclosed. The method includes receiving registration information of a plurality of drivers and storing the registration information of the drivers; receiving interconnection information of the drivers and storing the interconnection information of the drivers; receiving at least a request to control a specific driver of the drivers; searching the registration information for the specific driver; and referencing the interconnection information to determine whether the specific driver can be executed in response to the request.

According to an embodiment of the claimed invention, a resource managing device for drivers is disclosed. The device includes a driver registration unit for receiving registration information and receiving interconnection information of a plurality of drivers; a memory, coupled to the driver registration unit, for storing registration information and storing interconnection information of the drivers; a driver broker, coupled to the memory, for receiving at least a request to control a specific driver of the drivers; a processor, coupled to the driver broker and coupled to the memory, for searching the registration information for the specific driver; and referencing the interconnection information to produce a result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a resource managing device for drivers in a computing system according to an embodiment of the present invention.

FIG. 2 is a flowchart illustrating a method for resource management of drivers in a computing system according to an embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

Please note that the term pipeline, as used herein, is a concept and describes the grouping of multiple driver components. Additionally, the driver components are easily classified into any one of three types of driver components: a source driver component, a sink driver component, or a process driver component. For example, a given pipeline can have only one source driver component, but any number of process driver components connected thereafter to the source driver component and any number of sink driver components thereafter connected to the last connected process driver component. As will be seen later, the present invention is primarily concerned with the allocation of driver components to pipelines and with resolving driver component conflicts when multiple pipelines require the same driver component, therefore, for the scope of the present invention, it is not necessary to include said level of driver component detail to highlight the inventive aspects of the present invention. Rather, it is necessary to know that the spirit of the present invention is compatible with these, other existing driver classifications, organizational methods, and schemes.

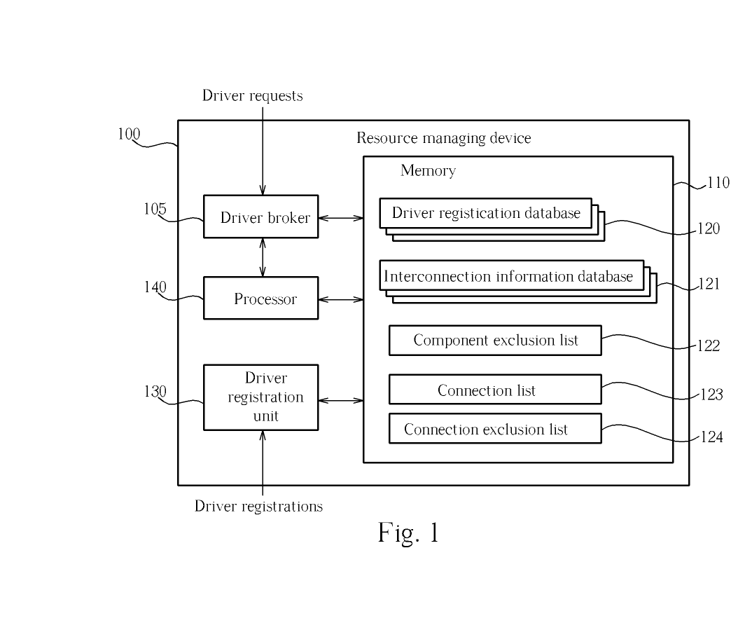

Please refer to FIG. 1. FIG. 1 is a block diagram of a resource managing device 100 for drivers in a computing system according to an embodiment of the present invention. In one embodiment of the present invention, the resource managing device 100 is embedded in a set top box and is operative during a set top box startup; however, this is not meant to be a limitation to the present invention. As shown in FIG. 1, the resource managing device 100 includes a driver broker 105, a processor 140, a memory 110, and a driver registration unit 130. The driver registration unit 130 is implemented for receiving registration information and receiving interconnection information of a plurality of drivers. For example, the driver registration unit 130, as shown in FIG. 1, registers (i.e., accepts registration information from the drivers) and stores said driver registration information into a memory 110 in the following way. The driver registration database 120 as described earlier, as well as, stored in the memory 110, are an interconnection information database 121, a component exclusion list 122, a connection list 123, and a connection exclusion list 124.

The memory 110 is coupled to the driver registration unit 130, the processor 140, and the driver broker 105. The memory 110 is utilized for storing registration information and storing interconnection information of the drivers as described earlier. The processor 140 is coupled to the driver broker 105 and the processor 140 is coupled to the memory 110. The processor 140 is utilized for searching the registration information stored in the memory 110 for the specific driver and referencing the interconnection information to produce a result.

The driver broker 105, coupled to the memory 110, receives at least a request to control a specific driver of the plurality of drivers. As shown in FIG. 1, stored in the memory 110 is a driver registration database 120. The driver registration database 120 is where the driver broker 105 tracks information about the registered driver components. This includes, but is not limited to or limited by, driver component information such as: name, ID, component group name, connection list, connection exclusion list, and component exclusion list. In the present invention, the driver broker 105 is designed to execute a conflict restore handler (not shown), a source connection handler (not shown), a driver component search engine (not shown), a pipeline handler (not shown), and a conflict resolver engine (not shown).

Specifically, the parts of the driver broker 105 are further described here. These details are provided as helpful background and to provide some degree of context to the present disclosure, however, the present invention is not limited as the following descriptions are offered as examples and not in any limiting manner. The pipeline handler, for example, can establish and destroy pipelines and track all of the driver components that are associated with an established pipeline. If a specific pipeline is being destroyed, but some driver components are still associated with the specific pipeline then the pipeline handler can notify all component handlers that the specific pipeline is being destroyed. Please note that the pipeline handler notifies the component handlers that the driver components of the specific pipeline to be destroyed based on, for example, the reverse order that the driver components were added to the pipeline sequence. Furthermore, handlers must communicate with driver components by way of the driver broker 105, in general, or any of the specific components of the driver broker 105 as described here and in the remainder of the disclosure, however, a callback or a notification from a driver component to the handler can either happen by way of the driver broker 105 or can bypass the driver broker 105. This example of driver communications is well known by those having average skill in this art and therefore additional details are herein omitted for the sake of brevity. Please note that the handlers are typically execution program code associated with computing systems and are considered the handler by virtue of having placed a request for a driver component. The component search engine, searches for a suitable component in the driver registration database 120 given a set of search parameters. The conflict resolve engine is responsible for determining how a conflict shall be resolved and if required will send notifications to the handlers that are involved with the conflict, specifically, the handler in control of the component in conflict. The connection handler is responsible for establishing a connection and notifying the handler once the connection has been established. The establishment of any connection by the connection handler may be an asynchronous process.

The following are additional details highlighting the workings of the components and their interactions with additional functionality defined as well. Obviously many changes can be made to the embodiment provided here while easily maintaining the spirit of the present invention. The driver registration unit 130 receives the component exclusion list 122 that defines at least one group of drivers that cannot be activated simultaneously and stores the component exclusion list 122 in the memory 110. The driver broker 105 may then receive a request for a first specific driver by a first pipeline and a second request for a second specific driver by a second pipeline, the driver broker 105 assigns the first pipeline with a first priority and the second pipeline with a second priority, and then the driver broker 105 references the component exclusion list 122 stored in the memory 110. If the first and second specific drivers belong to the same group, the driver broker 105 compares the first priority and the second priority to determine whether the first or second specific driver can be activated.

The driver broker 105 further assigns the first pipeline with a first flag and the second pipeline with a second flag, and the driver broker 105 further references one of the first and second flags to determine whether the specific driver can be activated when the first priority and the second priority are the same. There are many methods for achieving the same outcome of determining allocation of shared resources in a contentious environment as described herein. By way of example and not limitation, the examples provided herein for within the spirit of the present invention as are many that are not explicitly disclosed as they are well know to those having average skill in this art and are also obvious means for achieving the same outcome as, for example, the disclosed first and second flags as described earlier. Additionally, the driver registration unit 130 performs many tasks, including receiving a connection list 123 (stored in the memory 110) defining at least one group of drivers that can be connected in a specific order and stores the connection list 123 in the memory 110. Later, the driver broker 105 references the connection list 123 to check whether the specific driver and the another specific driver belong to the same group in the connection list 123 to determine whether the specific driver can be activated.

Additionally, the driver registration unit 130 receives and stores in the memory 110 a connection exclusion list 124 that defines at least one set of groups of drives, wherein the drivers in each group can be connected in a specific order, and driver connections defined by the groups of the set can not be activated simultaneously. Later, as needed based on handler requests, the driver broker 105 references the connection exclusion list 124 to check whether the specific driver and the another specific driver belong to different groups of the same set in the component exclusion list 122, wherein the specific driver and the another specific driver correspond to different driver connections and the driver broker 105 further compares the first priority and the second priority to determine whether the specific driver can be executed if the specific driver and the another specific driver belong to different groups of the same set in the component exclusion list 122.

Furthermore, the driver broker 105 assigns the first pipeline with a first flag and the second pipeline with a second flag, and then the driver broker 105 references one of the first and second flags to determine whether the specific driver can be executed when the first priority and the second priority are the same. For example, the driver broker 105 can then compare the first priority and the second priority to determine which of the first and second pipelines gets control of the specific driver. When the first priority and the second priority are the same, the driver broker 105 will assign the first pipeline with a first flag, the second pipeline with a second flag, and the driver broker 105 will reference one of the first and second flags to determine which of the first and second pipelines gets control of the specific driver.

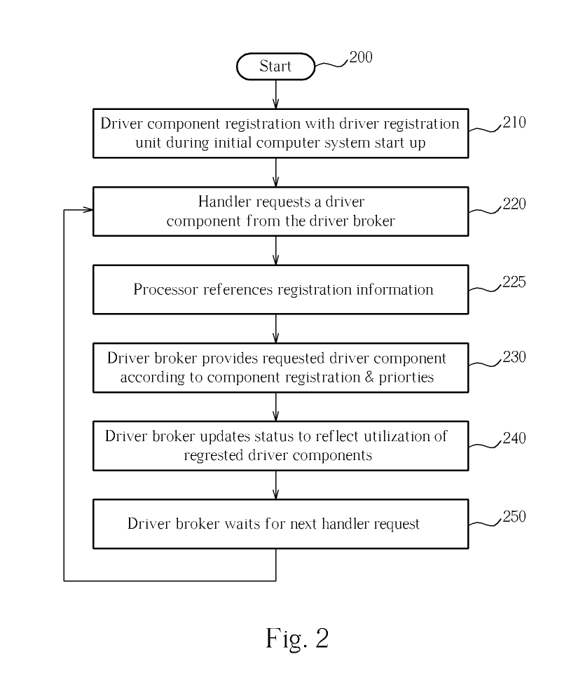

Please refer to FIG. 2. FIG. 2 is a flowchart illustrating a method for resource management of drivers in a computing system according to an embodiment of the present invention. The flow of the present invention is as follows:

Step 200: Start.

Step 210: The driver components register with driver registration unit 130 during initial computing system start-up.

Step 220: A handler requests a driver component from the driver broker 105.

Step 225: The processor 140 references the registration information to determine whether the specific driver can be activated in response to the request.

Step 230: The driver broker 105 provides requested driver component according to component registration and priorities.

Step 240: The driver broker 105 updates status to reflect utilization of requested driver components.

Step 250: The driver broker 105 waits for next handler request and driver registration. Return to step 220.

In step 200, the flow begins. In step 210, a driver component registers itself with the driver registration unit 130. This can happen during the initial start-up of the computing system. All driver components must be allowed to register themselves with the driver registration unit 130. In step 210, the driver component provides certain information during registration to the driver registration unit 130, specially, to the pipeline handler.

Please note, optionally any number of driver components can be grouped to form a single group or cluster of multiple driver components. Thereafter, the handlers can invoke the many members of a specific group utilizing a single request to the resource manager. For example, a commonly used group of driver components (i.e., several driver components that are commonly used in a particular configuration, perhaps defined by specific driver component database parameters) can be defined in the resource managing device 100. Handlers can now make a single request to the driver broker 105 for a single driver component (e.g., perhaps a group driver component) by specifying some driver component attributes like type and group.

Please note, in step 210, the present invention is not limited in what sort of driver registration information can be stored in the memory 110. For example, in the present embodiment, the driver registration unit 130 can receive a component exclusion list 122 that defines at least one group of drivers that can not be activated simultaneously and store the component exclusion list 122 in the memory 110. Another example is receiving a connection list 123 and storing the connection list 123 in the memory 110, wherein the connection list 123 defines at least one group of drivers that can be connected in a specific order. Finally, another example includes receiving a connection exclusive list 124 and storing the connection exclusive list 124 in the memory 110. The connection exclusive list 124 defines at least one set of groups of drives, wherein the drivers in each group can be connected in a specific order, and driver connections defined by the groups of the set can not be activated simultaneously.

In step 225, the processor 140 references the registration information to determine whether the specific driver can be activated in response to the request. Registration information is used generically herein, but can include for example, and not as to be limiting to the present invention, driver registration database 120, interconnection information data base 121, component exclusion list 122, connection list 123, and connection exclusion list 124, each of these stored in the memory 110.

Many examples of how the present invention can utilize various registration information in the memory 110 include, for example, referencing the connection list 123 to check whether the specific driver and the another specific driver belong to the same group in the connection list 123 to determine whether the specific driver can be activated when another specific driver is requested by a first pipeline and the specific driver is requested by a second pipeline.

In another example, if a specific driver is requested by a first pipeline, then the specific driver is requested by a second pipeline, then the first pipeline is assigned with a first priority and the second pipeline is assigned with a second priority. In another example, if the specific driver and the another specific driver belong to the same group, the processor 140 compares the first priority and the second priority to determine whether the specific driver can be activated. For example, the conflict resolution engine, previously described, could be implemented within the driver broker 105, to achieve this goal.

In another example, if the specific driver and the another specific driver belong to different groups of the same set in the component exclusion list, the processor 140 compares the first priority and the second priority to determine whether the specific driver can be executed, wherein the first pipeline is further assigned with a first flag, the second pipeline is further assigned with a second flag, and when the first priority and the second priority are the same, the processor 140 must reference one of the first and second flags to determine whether the specific driver can be activated.

In another example, the first pipeline is assigned with a first flag, the second pipeline is assigned with a second flag, and the processor 140 must compare the first priority and the second priority to determine whether the specific driver can be activated according to when the first priority and the second priority are the same and by referencing one of the first and second flags to determine whether the specific driver can be activated. For example, the conflict resolution engine, previously described, could be implemented within the driver broker 105, to achieve this goal.

In another example, a specific driver is requested by a first pipeline, the specific driver is requested by a second pipeline, the first pipeline is assigned with a first priority, the second pipeline is assigned with a second priority, and the processor 140 must reference the interconnection information database 121 stored in the memory 110 to determine whether the specific driver can be activated in response to the request, specifically, when referencing the connection exclusive list 124 to check whether the specific driver and the another specific driver belong to different groups of the same set in the component exclusion list 124, wherein the specific driver and the another specific driver correspond to different driver connections. For example, the component search engine, previously described, could be implemented within the driver broker 105, to achieve this goal.

In another example, the specific driver is requested by a first pipeline and a second pipeline, therefore the first pipeline is assigned with a first priority, the second pipeline is assigned with a second priority, and the driver broker 105 compares the first priority and the second priority to determine which of the first and second pipelines gets control of the specific driver. For example, the conflict resolution engine, previously described, could be implemented within the driver broker 105, to achieve this goal.

In some cases, the first priority and the second priority of the pipelines may be the same. When this happens, the driver broker 105 simply references one of the first and second flags to determine which of the first and second pipelines gets control of the specific driver. There are many methods and techniques for arbitration of limited resources in a contentious environment as is the case herein with respect to driver components and handlers of the present invention. By way of example and not limitation, a simply priority flag arbitration scheme is offered as an example, however, any similar method is within the scope and spirit of the present invention as is well known to those of average skill in this art. Again, for example, the conflict resolution engine, previously described, could be implemented within the driver broker 105, to achieve this goal. Further details and example are omitted hereinafter for the sake of brevity.

In step 230, the driver broker 105 provides the requested driver component according to component registration information and priorities of said components or pipelines. For example, the processor 140 will have already, in step 225, referenced the component exclusion list 122 to check whether the specific driver and the another specific driver belong to the same group in the component exclusion list 122 to provide the result for the driver broker 105 to act on in step 230. For example, the component search engine, previously described, could be implemented within the driver broker 105, to achieve this goal.

In step 240, the driver broker 105 updates the status of the driver components to reflect utilization of the requested driver components. In other words, having just responded to one of more driver component requests from one of more handlers, the driver broker 105 updates the driver registration database 120 to correctly indicate the new status of each requested driver component. For example, the connection handler, previously described, could be implemented within the driver broker 105, to achieve this goal.

In step 250, the driver broker 105 waits for next handler request at which time the flow returns to step 220 to accept the handler request and thereafter the flow continues again as previously described. For example, the pipeline handler, previously described, could be implemented within the driver broker 105, and would play a significant role to achieve this goal.

When receiving at least the registration information group comprising registration information of part of the drivers and when storing the registration information group in the memory 110 it is possible to receive a request for a group including the specific driver and when the processor 140 is searching the registration information the present invention can search for the registration information group corresponding to the group. Please note, this process can easily take place in the context of a set top box and especially during the startup process of said set top box.

Please note, the driver broker 105 can be configured to identify (i.e., flag) a specific drive component pipeline as not in use (e.g., a handler has terminated a connection therefore the specific existing pipeline is not longer needed) yet leave the specific pipeline in place to avoid rebuilding the entire pipeline if this specific pipeline is needed later. This offers an additional efficient to the present invention but is not a limitation of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A resource managing method for managing drivers, the method comprising:
receiving registration information of a plurality of drivers and storing the registration information of the drivers;
receiving interconnection information of the drivers and storing the interconnection information of the drivers;
receiving at least a request to activate and control a specific driver of the drivers;
searching the registration information for the specific driver; and
referencing the interconnection information to determine whether the specific driver can be activated and controlled in response to the request.

2. The method of claim 1, wherein the step of receiving the interconnection information of the drivers and storing the interconnection information of the drivers comprises:
receiving an optional component exclusion list and storing the component exclusion list, wherein the component exclusion list defines at least one group of drivers that can not be activated simultaneously.

3. The method of claim 2, wherein another specific driver is requested by a first pipeline, the specific driver is requested by a second pipeline, the first pipeline is assigned with a first priority, the second pipeline is assigned with a second priority, and the step of referencing the interconnection information to determine whether the specific driver can be activated and controlled in response to the request comprises:
referencing the component exclusion list to check whether the specific driver and the another specific driver belong to the same group in the component exclusion list; and
if the specific driver and the another specific driver belong to the same group, comparing the first priority and the second priority to determine whether the specific driver can be activated and controlled.

4. The method of claim 3, wherein the first pipeline is further assigned with a first flag, the second pipeline is further assigned with a second flag, and the step of comparing the first priority and the second priority to determine whether the specific driver can be activated and controlled comprises:
when the first priority and the second priority are the same, referencing one of the first and second flags to determine whether the specific driver can be activated and controlled.

5. The method of claim 1, wherein the step of receiving the interconnection information of the drivers and storing the interconnection information of the drivers comprises:
receiving a connection list and storing the connection list, wherein the connection list defines at least one group of drivers that can be connected in a specific order.

6. The method of claim 5, wherein another specific driver is requested by a first pipeline, the specific driver is requested by a second pipeline, and the step of referencing the interconnection information to determine whether the specific driver can be activated and controlled in response to the request comprises:
referencing the connection list to check whether the specific driver and the another specific driver belong to the same group in the connection list to determine whether the specific driver can be activated and controlled.

7. The method of claim 1, wherein the step of receiving the interconnection information of the drivers and storing the interconnection information of the drivers comprises:
receiving a connection exclusive list and storing the connection exclusive list, wherein the connection exclusive list defines at least one set of groups of drives, wherein the drivers in each group can be connected in a specific order, and driver connections defined by the groups of the set can not be activated simultaneously.

8. The method of claim 7, wherein another specific driver is requested by a first pipeline, the specific driver is requested by a second pipeline, the first pipeline is assigned with a first priority, the second pipeline is assigned with a second priority, and the step of referencing the interconnection information to determine whether the specific driver can be activated in response to the request comprises:
referencing the connection exclusive list to check whether the specific driver and the another specific driver belong to different groups of the same set in the component exclusion list, wherein the specific driver and the another specific driver correspond to different driver connections;
if the specific driver and the another specific driver belong to different groups of the same set in the component exclusion list, comparing the first priority and the second priority to determine whether the specific driver can be activated.

9. The method of claim 8, wherein the first pipeline is further assigned with a first flag, the second pipeline is further assigned with a second flag, and the step of comparing the first priority and the second priority to determine whether the specific driver can be executed comprises:
when the first priority and the second priority are the same, referencing one of the first and second flags to determine whether the specific driver can be activated.

10. The method of claim 1, wherein the specific driver is requested by a first pipeline and a second pipeline, the first pipeline is assigned with a first priority, the second pipeline is assigned with a second priority, and the step of receiving the request to execute the specific driver comprises:
comparing the first priority and the second priority to determine which of the first and second pipelines gets control of the specific driver.

11. The method of claim 10, wherein the first pipeline is further assigned with a first flag, the second pipeline is further assigned with a second flag, and the step of comparing the first priority and the second priority to determine which of the first and second pipelines gets control of the specific driver comprises:
when the first priority and the second priority are the same, referencing one of the first and second flags to determine which of the first and second pipelines gets control of the specific driver.

12. The method of claim 1, wherein the step of receiving registration information of a plurality of drivers and storing the registration information of the drivers comprises: receiving at least a registration information group comprising registration information of part of the drivers and storing the registration information group; the step of receiving the request to execute the specific driver of the drivers comprises: receiving a request for a group including the specific driver; and the step of searching the registration information for the specific driver comprises: searching the registration information for the registration information group corresponding to the group.

13. The method of claim 1, wherein the step of receiving the registration information of the drivers and storing the registration information of the drivers is performed during a set top box startup.

14. A resource managing device for managing drivers, the device comprising:
a driver registration unit for receiving registration information of a plurality of drivers and receiving interconnection information of the drivers;
a memory, coupled to the driver registration unit, for storing the registration information and the interconnection information;
a driver broker, coupled to the memory, for receiving at least a request to execute a specific driver of the drivers;
a processor, coupled to the driver broker and coupled to the memory, for searching the registration information for the specific driver; and referencing the interconnection information to determine whether the specific driver can be executed in response to the request.

15. The device of claim 14, wherein the driver registration unit receives a component exclusion list that defines at least one group of drivers that can not be executed simultaneously and stores the component exclusion list in the memory.

16. The device of claim 15, wherein the driver broker receives another specific driver request by a first pipeline and the specific driver is requested by a second pipeline;
the driver broker assigns the first pipeline with a first priority and the second pipeline with a second priority; and the driver broker references the component exclusion list stored in the memory and if the specific driver and the another specific driver belong to the same group, the driver broker compares the first priority and the second priority to determine whether the specific driver can be executed.

17. The device of claim 16, wherein the driver broker further assigns the first pipeline with a first flag and the second pipeline with a second flag; and the driver broker further references one of the first and second flags to determine whether the specific driver can be executed when the first priority and the second priority are the same.

18. The device of claim 14, wherein the driver registration unit receives a connection list defining at least one group of drivers that can be connected in a specific order and stores the connection list in the memory.

19. The device of claim 18, wherein the driver broker references the connection list to check whether the specific driver and the another specific driver belong to the same group in the connection list to determine whether the specific driver and another specific driver can be connected.

20. The device of claim 14, wherein the driver registration unit receives and stores in the memory a connection exclusion list that defines at least one set of groups of drives, wherein the drivers in each group can be connected in a specific order, and driver connections defined by the groups of the set can not be activated simultaneously.

21. The device of claim 20, wherein the driver broker references the connection exclusion list to check whether the specific driver and the another specific driver belong to different groups of the same set in the component exclusion list, wherein the specific driver and the another specific driver correspond to different driver connections and the driver broker further compares the first priority and the second priority to determine whether the specific driver can be executed if the specific driver and the another specific driver belong to different groups of the same set in the component exclusion list.

22. The device of claim 21, wherein the driver broker further assigns the first pipeline with a first flag and the second pipeline with a second flag; and the driver broker references one of the first and second flags to determine whether the specific driver can be executed when the first priority and the second priority are the same.

23. The device of claim 14, wherein the driver broker compares the first priority and the second priority to determine which of the first and second pipelines gets control of the specific driver.

24. The device of claim 23, wherein the driver broker further assigns the first pipeline with a first flag and the second pipeline with a second flag; the driver broker references one of the first and second flags to determine which of the first and second pipelines gets control of the specific driver when the first priority and the second priority are the same.

25. The device of claim 14, wherein the driver registration unit receives at least a registration information group comprising registration information of part of the drivers and further stores the registration information group in the memory; the driver broker receives a request for a group including the specific driver; and the processor searches the registration information for the registration information group corresponding to the group.

26. The device of claim 14, wherein the driver registration unit receives the registration information and stores the registration information into the memory during a set top box startup.
